(19) United States
(12) Patent Application Publication
(10) Pub. No.: US 2019/0354919 A1
(43) Pub. Date: Nov. 21, 2019

(54) METHODS AND SYSTEMS FOR AUTOMATING PACKAGE HANDLING TASKS THROUGH DEEP-LEARNING BASED PACKAGE LABEL PARSING

(71) Applicant: FARRUKH MAHBOOB, New York, NY (US)

(72) Inventor: FARRUKH MAHBOOB, New York, NY (US)

(21) Appl. No.: 16/531,474

(22) Filed: Aug. 5, 2019

Related U.S. Application Data
(60) Provisional application No. 62/714,898, filed on Aug. 6, 2018.

(51) Int. Cl. G06Q 10/08; G06T 19/00; G06F 17/27; G06K 7/14; G06F 16/2458; B07C 3/12; B07C 3/20

(52) U.S. Cl. CPC G06Q 10/083; G06T 19/006; G06F 17/2765; B07C 2301/0066; G06F 16/2468; B07C 3/12; B07C 3/20; G06K 7/1434

(57) ABSTRACT

A system and method for routing of one or more incoming packages. The process may entail capturing one or more images of each respective package of the one or more incoming packages and extracting data from the one or more captured images. The extracted data is used for determining likelihood of whether an intended recipient exists by comparing extracted data with a members list from one of more databases and generating a notification to the intended recipient responsive to determining that the intended recipient exists. Otherwise, generating a list of possible recipients responsive to determining a likelihood that a group of potential users are the intended recipient.

### CROSS REFERRENCE TO RELATED DISCLOSURE

This disclosure claims the benefit of priority from pending U.S. Provisional Patent Application No. 62/714,898, filed on Aug. 6, 2018, and entitled “Methods And Systems For Processing And Outputting Delivery Data Based On Implementation Of Trainable Neural Network”, which is incorporated herein by reference in its entirety.

### TECHNICAL FIELD

The present disclosure generally relates to the field of computerized systems. More particularly, the disclosure relates to systems and methods for automating package handling tasks by parsing off the information from the package label through performing OCR on the label image and applying deep-learning, pattern matching, and text matching techniques. This information is useful for certain package handling tasks like routing a package to a correct recipient, package sorting within a mailroom, and novel package pickup approaches which allow for efficiency and accuracy.

### BACKGROUND

Conventional systems permit a party to place an order for goods through various sources such as online, over the telephone, or by mail. For example, using a computer or mobile device, a party may access a website of a retailer to select a desired good or product and place an order. The retailer may receive information from an ordering party regarding the ordering party including a name and/or address associated with package delivery. For example, a party may provide his/her own name and address.

The retailer may then ship packages of the order to the party at his/her name and/or address utilizing a shipping company. In instances, a party's address may be in an office or apartment building where there may be numerous potential recipients. Often referred to as the last-mile or last 100-feet problem of package delivery, a connection between a courier and an end-user has been missing for a long time. At times, this role is fulfilled by a team of package riders who bridge the gap between the courier and a target package recipient. In other instances, human office resources, such as receptionists or administrative assistants, must take out extra time from their primary job to manage deliver of any packages as well. While recent advances in the courier industry in the direction of last-mile delivery, such as use of drones and other package drop-in options, some issues related to last-mile delivery may obviate dependence on designated bike riders, the last-mile problem is not being addressed in context of the setting of co-inhabiting and co-working spaces.

In the setting of co-inhabiting and co-working spaces, a courier usually does not have a direct access to its end users (target package recipient), with the building staff acting as an abstraction layer between the two. Often, this is due to a building administration's preference for self-managing day-to-day operations within its physical space. Moreover, because of the transitory nature of a visitor's or user's stay within such a space, live updates of an end user's (who may be a target recipient) activities including location might only be available to the building administration. Due to privacy concerns, whether government mandated or due to personal preferences, a building administrator may not be willing to share live information regarding a target package recipient with any third parties. Typically, building managers/administrators receive numerous complaints from its inhabitants regarding delay in informing them about packages, misplaced packages, or other miscellaneous problems of a similar nature. On the end of managers, they often have a not-much-coveted task of manually notifying each individual about their packages, which consumes their time and energy.

Hardships related to last-mile deliveries may be attributed to an absence of an end-to-end fully automated system encompassing all services and relevant processes like identifying a recipient, sending prompt notifications, and tracking of all the activities and information related to delivery of packages.

Accordingly, what is needed are systems and methods for better management and smoother and faster execution of package deliver tasks within a co-working space allowing for minimizing impact of package delivery tasks on the efficiency and productivity of building receptionists and mailrooms assistants.

### SUMMARY

The present invention pertains to methods and system designed for providing fully automated package handling solution for environment similar, but not limited, to co-working and co-living spaces. The solution has been implemented to automate the processes related to all phases of last yard of package delivery, with key emphasis on obtaining structured information from text, of the package, for faster, yet correct routing of packages.

According, to one exemplary embodiment, an exemplary method for routing of one or more incoming packages, comprising capturing one or more images of each respective package of the one or more incoming packages and extracting data from the one or more captured images. The exemplary method may further comprise of determining likelihood of whether an intended recipient exists by comparing extracted data with a members list from one of more databases associated with a physical location and generating a notification to the intended recipient responsive to determining that the intended recipient exists. Furthermore, the method may comprise generating a list of possible recipients responsive to determining a likelihood that a group of potential users are the intended recipient and sending a notification to the intended recipient. For pickup, the method may include associating a physical space with a virtual space in the mailroom and associating a respective location in the virtual space with the respective package, and displaying the respective location.

According, to one exemplary embodiment, an exemplary system for routing of one or more incoming packages, comprising a processor and a storage device that stores a set of instructions that when executed by the processor perform a method, the method comprising capturing one or more images of each respective package of the one or more incoming packages and extracting data from the one or more captured images. The exemplary method may further comprise of determining likelihood of whether an intended recipient exists by comparing extracted data with a members list from one of more databases associated with a physical location and generating a notification to the intended recipient responsive to determining that the intended recipient exists. Furthermore, the method may comprise generating a list of possible recipients responsive to determining a likelihood that a group of potential users are the intended recipient and sending a notification to the intended recipient. For pickup, the method may include associating a physical space with a virtual space in the mailroom and associating a respective location in the virtual space with the respective package, and displaying the respective location.

Additional features and advantages would become apparent, partly, upon careful and in-depth examination and understanding of the description of the invention, explained with the help of various exemplary embodiments, and partly through the practical use/observation of the invention. The examples have been expounded to increase the understanding of the spirit or cardinal functionality of the invention, but this may not be considered as a limitation or confinement of scope of invention. The invention has the capacity to perform in various other capacities, subject to minor modifications in different aspects, adhering to the devised scope of the invention. Accordingly, all examples, figures and claims should be taken as merely the illustrations of the invention and not limitations.

### BRIEF DESCRIPTION OF THE DRAWINGS

In the accompanying drawings, the features of the invention have been emphasized and preferred embodiment has been illustrated as an example. The diagrams are not drawn necessarily to scale but rather focus on clearly illustrating the intended functionality of the present disclosure. Throughout the diagrams, like reference numerals are assigned to same parts which have been incorporated in different views.

FIG. 1A illustrates a flowchart of a method for automating package delivery, consistent with one or more exemplary embodiments of the present disclosure.

FIG. 1B shows a block diagram depicting a flow for providing notifications about incoming packages, consistent with one or more exemplary embodiments of the present disclosure.

FIG. 1C shows a flow diagram of a notification process, consistent with one or more exemplary embodiments of the present disclosure.

FIG. 2 illustrates a scanning screen of a mobile application, consistent with one or more exemplary embodiments of the present disclosure.

FIG. 3 illustrates a Non-Member screen of a mobile application which appears upon scanning a package label of person who is not in database, consistent with one or more exemplary embodiments of the present disclosure.

FIG. 4 illustrates a Package Details screen of a mobile application, consistent with one or more exemplary embodiments of the present disclosure.

FIG. 5 illustrates a Collect Signature screen of a mobile application, consistent with one or more exemplary embodiments of the present disclosure.

FIG. 6 illustrates an exemplary screen of a web dashboard, consistent with one or more exemplary embodiments of the present disclosure.

FIG. 7 illustrates another exemplary screen of a web dashboard, consistent with one or more exemplary embodiments of the present disclosure.

FIG. 8 is a high-level block diagram showing package sorting and categorization flow, consistent with one or more exemplary embodiments of the present disclosure.

FIG. 9 illustrates a block diagram for exemplary flow of handing over the package to a recipient, consistent with one or more exemplary embodiments of the present disclosure.

FIG. 10 shows diagram of exemplary system for notifying, routing and checking out of processed packages according to embodiments of the invention, consistent with one or more exemplary embodiments of the present disclosure.

FIG. 11 shows high level schematic diagram of the system, with device specifications, consistent with one or more exemplary embodiments of the present disclosure.

### DETAILED DESCRIPTION

The preferred embodiment and few other examples demonstrating the versatility of the invention, disclosing certain features and processes, described herein, with reference to the accompanying drawings, is solely for the purpose of illustration to enable those expert in the field to further explore the possible aspects and functionalities that are aligned with the principles of the invention and to provide guidance in implementing and practicing the invention.

In an exemplary embodiment, exemplary systems and methods may be utilized to find the correct recipient of a package by scanning the package using a scanning device.

Exemplary embodiments consistent with the present disclosure include an automated solution for the above-mentioned problems using Optical Character Recognition (OCR) coupled with Artificial Intelligence and pattern matching techniques to ease the handling of incoming packages and effectively notifying the recipient of each package.

Exemplary systems and methods may be utilized at co-working spaces, residential buildings, corporate and government offices, hospital settings, shopping malls, educational campuses, dormitories, sports complexes, warehouses, fulfilment centers and other package pickup and drop-off points.

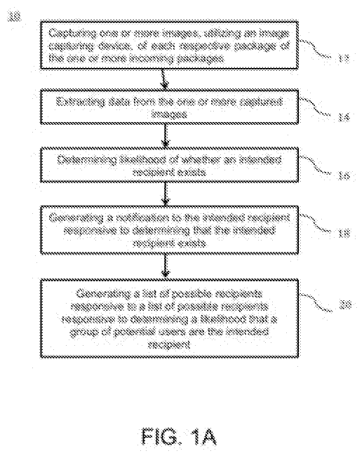

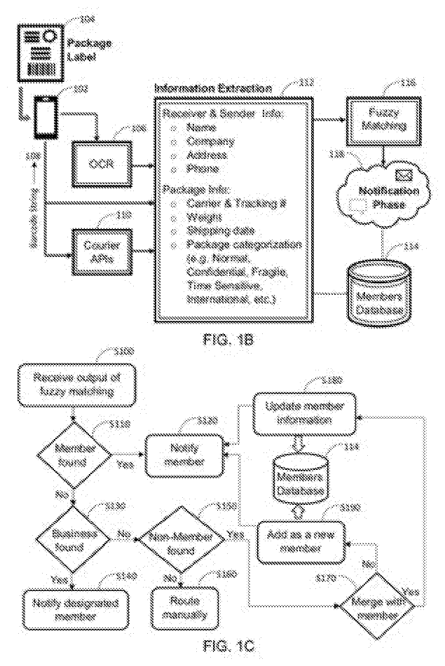

FIG. 1A, illustrates a flowchart of a method for automating package delivery, consistent with one or more exemplary embodiments of the present disclosure. Specifically, method 10 may allow for routing of one or more incoming packages. While exemplary method 10 illustrates an overall process, analogous steps consistent with exemplary embodiments are described below in context of FIGS. 1B to 11.

Step 12 may entail capturing one or more images, utilizing an image capturing device, of each respective package of the one or more incoming packages. In an exemplary embodiment an image capturing device or a scanning device may capture image data. In an exemplary embodiment, image capturing device may be a handheld device which may be configured to capture an image. In an exemplary embodiment, image capturing device may capture a main image of a high resolution responsive to a command to capture an image. In an exemplary embodiment, image capture device may additionally capture up to 30 frames, along with capturing the high resolution frame. In an exemplary embodiment, pre-processing techniques may be applied on the captured image such as skew detection and correction, background removal, etc., to improve performance of an exemplary OCR engine on a given image.

Step 14 may entail extracting data from the one or more captured images. In further detail, step 14 may comprise of extracting text from the one or more captured images by performing Optical Character Recognition. In an exemplary embodiment, post-processing techniques may be applied on the extracted text such as text-cleaning by removing unwanted characters, encoding and decoding the text, text-formatting by forming blocks of contiguous text on the basis of spatial information of words present in raw OCR text.

Exemplary systems and methods may allow for extracting critical pieces of sender and receiver's information via a conjunction of following approaches to accurately locate, read and categorize the required and relevant fragments of information. In an exemplary embodiment, Deep Learning based Object detection and Name Entity Recognition (NER) algorithms may be utilized. In an exemplary step sender and receiver regions on a label may be utilized. Subsequently, respective text within the localized regions may be parsed into different entities. In an exemplary embodiment, positions of relevant regions, e.g., regions containing sender information and receiver information may be determined through deep learning-based object detection approach, backed by a fallback strategy of locating the sender and receiver regions on the package label by using regular expressions-based pattern matching. In an exemplary embodiment, regions may be determined utilizing regular expressions-based pattern matching comprises of locating the address lines in the package using regular expressions and then forming a bounding box of appropriate dimensions around that line to extract the localized text relevant to sender and receiver.

In an exemplary embodiment, a deep learning-based approach may involves using object detection algorithm Faster R-CNN for the purpose of drawing a bounding box around a Region of Interest (ROI) on a package label. The ROIs may include sender info region, receiver info region, barcode region, courier info region, etc. In an exemplary embodiment Faster R-CNN locates regions on the package label image by outputting the name of that region as well as the coordinates of the bounding box which encapsulates that specific region. Subsequently, text contained in that specific region may be parsed into components including, but not limited to, name, organization, street address, city, state, country, phone number, etc., by using an exemplary deep learning based NER module. An architecture of an exemplary NER module may contains combination of Bidirectional LSTM (Long Short-Term Memory), CNN (Convolutional Neural Network) and CRF (Conditional Random Field) for labelling the aforementioned entities present in the localized text. The robustness of an exemplary module may be ensured by training it with a large private dataset. Additionally, utilizing exemplary approaches, information from barcodes may be extracted in order to succor in consolidating the validity and confidence of picking the correct target recipient member and in gathering useful pieces of courier-services-related information of the package, as described in further detail below.

In an exemplary embodiment, exemplary barcode parsers may be utilized to parse wide range of tracking numbers belonging to different courier companies. Furthermore, an exemplary method may identify a package as falling into numerous categories based on time-sensitivity, weight, fragility, etc. In an exemplary embodiment, the exemplary categories may include, but are not limited to, being marked as time-sensitive, fragile, regular, etc. In an exemplary embodiment, exemplary notifications or reminders regarding the package may be based on the respective categories.

Step 16 may entail determining likelihood of whether an intended recipient exists by comparing extracted data with a members list from one of more databases associated with a physical location. In an exemplary embodiment, the comparing may comprise determining a likelihood based on information in an exemplary database based on the extent of similarity and closeness to the information available on the package. In an exemplary embodiment, the exemplary members list may contain names and associated information of all members (possible target recipients) at a physical location, such as a co-working space.

Step 18 may include generating a notification to the intended recipient responsive to determining that the intended recipient exists. In an exemplary embodiment, determining that the intended recipient exists may entail regarding a potential candidate or receiver with a score above a certain threshold as the target recipient of the package. In an exemplary embodiment, a score above a certain threshold may include certainty above ninety percent that the member/target package recipient exists in the database. In an exemplary embodiment, a notification may be sent as described further below in the specification.

Step 20 may include generating a list of possible recipients responsive to a list of possible recipients responsive to determining a likelihood that a group of potential users are the intended recipient. In an exemplary embodiment, for candidates which do not meet the required threshold of step 10 for determining that a potential recipient definitely exists, candidates lying in a specific score range may be fetched as potential or suggested recipients. For example, this may be a list of potential recipients with a range of seventy to ninety percent confidence. Accordingly, a user may manually choose from the various options presented.

In an exemplary embodiment, in instances where a confidence match is not found in step 18 and in step 20, there are no candidates above a suggestion threshold, exemplary systems and process may prompt a user/building administrator to enter information related to a new member. In an exemplary embodiment, information related to a new member may be stored in an exemplary database so for any subsequent deliver for the exemplary member, their information may be contained within the exemplary database.

In an exemplary embodiment, a notification may be sent to the recipient where the notification may provide information regarding the incoming package. In an exemplary embodiment, the content and mode of the notifications regarding incoming packages maybe dictated by a member's preferences or based on administrator settings.

In an exemplary embodiment, any information obtained regarding a respective package obtained at different steps of method 10 may be logged or stored. In an exemplary embodiment, logging or storing package information may allow for enabling better tracking of a package and to provide a comprehensive view of the package by automatically reading and storing, essentially every piece of information available on the swathe of package label.

Exemplary methods and systems also provide for a process of handing over a package to an intended recipient of the package. In an exemplary embodiment, a member may entrust another person to pick the package on their behalf. However, in any case, strict authorization steps, like fingerprint match, facial signature, etc. for digitally signing out the package, may be performed to ensure that the package has been handed over to the authorized person, thus, maintaining the security, privacy and confidentiality of the member's data and their activities. Details of phase of package-pickup may be sent as a notification to the recipient, as well as any other member who has picked the package on the recipient's behalf.

The method and system, typically allows for checking out the package through one of the two approaches, that is, Manual-Checkout and Auto-Checkout, designed to make the process convenient, fast and hassle-free for both, the mailroom person and the recipient that has come to pick up their package. To elucidate Auto Checkout, the image/actual package label, when readily available, may be re-scanned through the auto pickup flow, which automatically triggers the searching mechanism to look up for the package in the database, primarily through barcode information for faster retrieval of results. If the latter method fails, the mechanism may be fabricated to fall back on the OCR-text based member extraction with altered sequence and preferences of different internal flows. Upon failure of Auto Checkout to find the package, and the associated member in the database, and when the package label is not conveniently available for scanning, manual checkout flow may be utilized. Salient features, inclusive of search through the name of the person to whom the package has been routed, the receiver or sender information available on package, or any text that is transcribed on the package label, may be integrated, to improve the search of package by broadening the domain of searchable parameters.

In an exemplary embodiment, the physical placement of a package may be found by utilizing Augmented Reality (AR) based techniques. Exemplary AR techniques may involve scanning a mailroom or a similar locality where any packages would be stored, to generate a 3D-layout of the room. The position of the package, along with its tracking number may be recorded, by scanning the package and its position. This information may be utilized for guiding the mailroom person to the position where a certain package has been placed.

Further details of exemplary systems and exemplary processes are provided in exemplary embodiments are presented below in the context of the corresponding figures.

In an exemplary embodiment, in FIG. 1B, an image capturing device (such as a camera) of smartphone 102 may be used to capture an image of package label 104. In an exemplary embodiment, another image capturing device coupled or associated with a processor may be utilized in lieu of Smartphone 102. In an exemplary embodiment, package label 104 may contain textual information, as well as courier-specific barcodes 108.

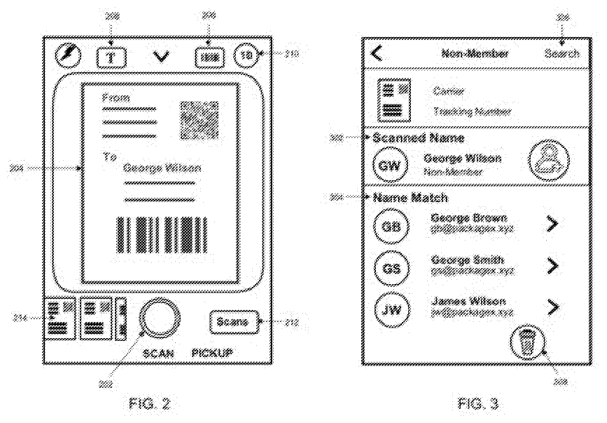

Additionally, an exemplary scanning device such as smartphone 102 may be configured to provide digital assistance to a user in capturing proper images, leading to enhancement in overall performance of the exemplary. FIG. 2 illustrates a scanning screen of a mobile application, consistent with one or more exemplary embodiments of the present disclosure. Specifically, FIG. 2 illustrates a “Scanning” screen which allows user to capture an image of package label 204 by pressing scan button 202. Certain indicators like text 208 and barcode 206 detection, map provide insight to a user for capturing valid images containing information of a label. The scans tab 212, count tab 210, and preview lane 214 may allow a user to navigate to the scanned packages as well as to see a count and thumbnails of scanned packages. Scanned packages may refer to packages labels that may have been scanned but yet not routed to anyone.

In an exemplary embodiment, for 1-dimensional (1-D) barcodes (e.g., Code 128, Code 39, UPC, EAN, IMB, Databar, etc.), barcode detection may be more dependent on camera angles and perspectives in the image than the resolution of the image. However, the image resolution may become a limiting factor when it comes to 2-dimensional (2-D) barcodes (e.g., PDF 417, QR code, Aztec code, Data Matrix, Maxicode, etc.). Accordingly, exemplary methods may detect a barcode from a captured image as well as from a live feed of a smartphone camera. In an exemplary embodiment, a live camera feed, although low-resolution, may allow for more variations in angles and perspective when the barcode is detected across a series of frames, in comparison to just one frame.

In an exemplary embodiment, in order to scan multiple packages in an exemplary batch mode, a plurality of number of frames may be utilized for bar code detection. In an exemplary embodiment, 30 or lesser number of frames may be captured before capturing a high-resolution image. In an exemplary embodiment, the high-resolution captured image may be used to detect the 2-D barcodes. The extent of the information contained in the barcode may vary for each courier delivering a respective courier. For example, couriers like USPS and DHL, use 1-D barcodes (Code-128 primarily), therefore they are able to encode very little information (tracking number and postal code) inside the barcode. While others like FedEx and Purolator prefer to use the 2-D barcodes (PDF 417), therefore, being able to encode all sorts of information, including receiver and sender details, to package-specific information like package weight, package count, etc. Furthermore, couriers like UPS have launched their own barcode variations i.e., Maxicode. In short, encoding formats used by most of the couriers vary from the rest (especially for 2-D barcodes). Accordingly, exemplary systems and methods contain barcode parsers for each respective courier.

In addition to the information contained within barcodes, couriers may also provide more courier-specific details, e.g., package pickup date, package delivery date, shipment service obtained, etc., by using their public Application Program Interface (APIs). In an exemplary embodiment, Information Extraction module 112 may combines all the extracted information from a barcode and use it to fetch some more information from a publicly available Courier APIs 110 and then combines everything to generate a holistic view of a respective package.

In an exemplary process, an image of a package label 104 may be sent for OCR. An exemplary OCR engine may be utilized for OCR, such as OCR engine 106 that may comprise an open-source solutions like Tesseract or a commercial option such as like ABBYY Finereader, Google Vision, Nuance OmniPage, etc. In an exemplary embodiment, custom-trained OCR solutions may be utilized. In an exemplary embodiment, both on-device and on-cloud OCR options may be utilized, or an exemplary hybrid approach may be utilized. For example, all captured images related to packages may first go through an on-device OCR module and undergo some smoke tests to validate the success of on-device OCR. In an exemplary embodiment, smoke tests may include establishing the validity of the OCR and finding an exact recipient of the package from the database. In case of a failure of on-device OCR, a captured image may then be sent to the an on-server OCR solution. In an exemplary embodiment, an OCR solution may have more resources available at its disposal allowing for a retry of an OCR at the exemplary on-server level to have a higher chance of success.

In an exemplary embodiment, following the exemplary hybrid may allow in case of a successful on-device OCR to continue the rest of an exemplary process instantly without wasting any time related to image upload to an exemplary server.

In an exemplary embodiment, Information Extraction module 112 may work on the OCR output and extract its own version of values of each field. In an exemplary embodiment, extracted version of its values may be recipient's name, recipient's phone, recipient's organization, recipient's address, sender's name, sender's phone, sender's organization, sender's address, category of package (e.g., fragile, confidential, etc.), tracking number, weight of package, etc. In an exemplary embodiment, extraction module 112 may be implemented in multiple ways, using exemplary approaches as described throughout the disclosure.

In an exemplary embodiment, after initial extraction of data related to a target recipient based on extracting information from a label, including from barcodes and utilizing OCRed text, an exemplary system may utilize that the extracted information to determine an identity of a target recipient and provide notifications from them.

In a first exemplary scenario, Notification Phase 118 may take an output of Fuzzy Matching 116 and utilize that information to notify a target recipient. In an exemplary embodiment, Fuzzy Matching 116 may use the receiver information (name, business name, office number, floor number, phone number) to ascertain the recipient of the package by juxtaposing it with corresponding pieces of information of members in a Member Database 114. In an exemplary embodiment, an exemplary fuzzy Matching technique may provide marginal room to cater for slight error.

FIG. 1B shows a block diagram depicting a flow for providing notifications about incoming packages, consistent with one or more exemplary embodiments of the present disclosure. Specifically, an input may be received from the Fuzzy Matching 116 module at S100. If a match is found at S110, the member may be notified in S120 via an email/SMS, along with an image of package label 104 and extracted information in an email, thus providing the notified member with a complete information about a certain package.

In an exemplary embodiment, when a target packet recipient or member has left the building but their mail arrives. In that case, the Ex-Member may be notified with a warning to pick the package within a stipulated period or their package would be discarded. In an exemplary embodiment, if requested, the re-routing of Ex-Member packages may be to their home address at their own expense. If the match for a member is unsuccessful, the exemplary process may look for a match against a Business Name at S130. If successful in identifying a package addressed to a business, the designated pickup member at the business may notified in S140. Alternatively, the Non-Member at S150 flow may take over.

In an exemplary embodiment, Non-Member flow may represent a scenario in which there is a lack of confidence in linking the receiver name on the package with any of the members in the Member Database 114. In an exemplary embodiment, an exemplary Name Entity Recognition (NER) system, may extract a name, along with spatial information to precisely locate the receiver name on the package.

In an exemplary embodiment, the extracted output may be further passed through a set of validation to filter out non-relevant values.

Exemplary approaches allow for efficient recognition of information associated with a target package recipient under non-ideal conditions pertaining to acute variation in layout and/or the pattern of names. Additionally, exemplary approaches allow to deal with instances in which a package belongs to a member whose information is not pre-stored in an exemplary database. In a scenario, where a member is not present in the database, a user, also known as the Mail Room Associate (MRA), may be prompted to intervene and decide the course of action for the package in question.

FIG. 3 illustrates a Non-Member screen of a mobile application which appears upon scanning a package label of person who is not in database, consistent with one or more exemplary embodiments of the present disclosure.

In detail, FIG. 3 shows an exemplary scenario in which a Non-Member screen where a package belonging to a person named as “George Wilson” is scanned but that person is not in an exemplary database. Exemplary systems pick the correct name, shown as Scanned Name section 302 on the screen. Name Match section 304 may show the closest matches from an exemplary database, on the basis of names, as suggestions. In an exemplary embodiment, suggestions may show up on basis of other entities as well, e.g., phone, business, office number, etc.

The MRA may link the package with an existing member from the suggestions at S170, in which case the name on the package may be added as an alternate name to the member, the package may be linked to, leading to the information update of member at S180, or may be added as new member at S190 and notify in S120. If the member is not detected, the user may manually route the package at S160 using the search option 306. Or the user may simply delete the scanned package by tapping on the delete icon 308. Delete functionality may be available for any package that has been scanned.

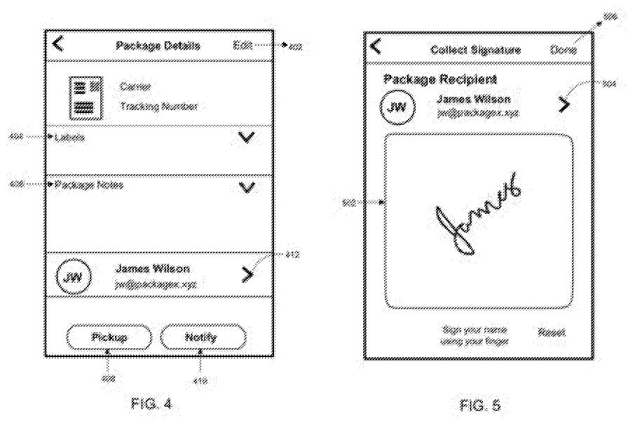

In an exemplary embodiment, when a package has been assigned to a potential recipient or a member, a user may check information or details related to the package. FIG. 4 illustrates a Package Details screen of a mobile application, consistent with one or more exemplary embodiments of the present disclosure. Specifically, package details screen 400 in FIG. 4 displays the information extracted from a specific package, e.g. carrier, tracking number, etc. This information may be edited by tapping on button 402. For example, a user may change a recipient by pressing on Edit 412 and selecting a member from the list that subsequently shows up. Additionally, a user may add Package Notes 406 which may be incorporated in the content of a notification that is to be sent to the user/target recipient. Relevant actions may include either letting the receiver pick up the package in case he/she is present by tapping on Pickup 408 or notifying the member by using Notify 410. Once notified or picked up, a package may be stored in the packages' directory of the selected receiver.

In an exemplary embodiment, a user may have a view of members' information and their packages. FIG. 6 illustrates an exemplary screen of a web dashboard, consistent with one or more exemplary embodiments of the present disclosure. Specifically, in FIG. 6, a screen of a web dashboard 600 is shown which may appear upon navigating to dashboard 600. Here, a user may look at details of a member in Individual Information section 602. Information in individual information section 602 may be edited, subject to access level of the user. Similarly, button 604 may show various views of each the packages belonging to a specific member, along with their status and other relevant details (e.g., check-out time, etc.). In an exemplary embodiment, search bar 606 may enable a search for members in an exemplary database.

In an exemplary embodiment, similar information may be extracted through the flows integrated into mobile applications. Similarly, navigating to packages tab 702 in dashboard may lead to the view depicted in FIG. 7. Section 706 exhibits logs of packages in a certain building. This view across different buildings may be accessed by the user, provided he/she has adequate rights. Multiple filtering options may be employed to see different relevant analytics or to search for any particular information.

Exemplary systems and methods may be utilized to extract information from a package label, generically, independent of database. Additionally, exemplary systems and methods may accurately parse information of sender and receiver. Coalescence of techniques like Pattern matching, NER, and localization of ROI (Region of Interest) may be leveraged to extract essential pieces of information like name, phone and business/organization of sender and recipient, with high accuracy. In an exemplary embodiment, the particulars of information captured may be saved in searchable log files for maintaining records and efficient tracking.

In an exemplary embodiment, raw OCR text provided by an exemplary OCR engine may be easily searchable through a query. In an exemplary embodiment, being able to query raw OCR text may aid in in enhancing searching functionality by letting a user to search for a package by any word that he or she sees/remembers from a package label. This exemplary approach may be helpful in scenarios, similar to, where the user is unable to recall much of the detail of the package to search for it. In an exemplary embodiment, a text search may be conducted by selecting the “Text” option on toggle button 704. Search toggle button 704 may allow for searching for a package through different details like member info, tracking number, etc. when “Basic” is selected.

In an exemplary embodiment, the exemplary process may be utilized for a wide array of languages used across the globe, e.g., English, Spanish, Portuguese, French, German, Chinese, Korean, Hebrew, Japanese, Indonesian, Thai, Dutch, Swedish, Polish, Italian, Vietnamese, Russian, Czech, etc. Principles of exemplary methods may therefore allow for use of exemplary techniques with different languages allowing for use of exemplary approaches in various language zones. In an exemplary embodiment, a user may use language preference option to choose a language in accordance with the information on package label and scan the package without any inconvenience. The underlying exemplary functionality may allow for fetching information related to a target recipient from an exemplary database, irrespective of the variation in input text in terms of language.

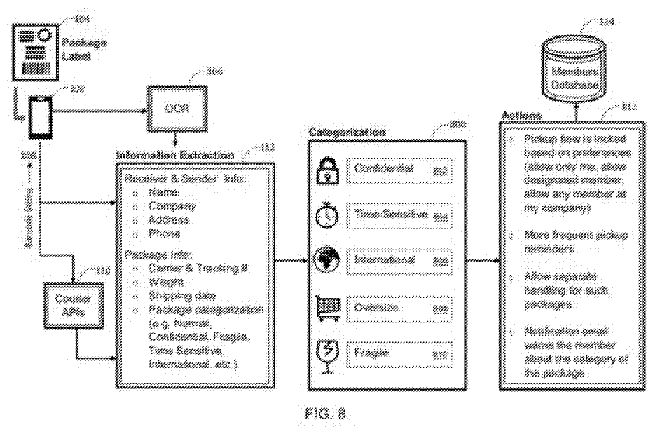

FIG. 8 is a high-level flow diagram showing package sorting and categorization, consistent with one or more exemplary embodiments of the present disclosure. In detail, by using an output of the Information Extraction module 112, a package may be classified as belonging to one of the six categories in classification module 800, namely Routine (not illustrated), Confidential 802, Time-Sensitive 804, International 806, Oversize 808, Fragile 810. In an exemplary embodiment, the detected categories may appear under labels tab 404 of FIG. 4. In an exemplary embodiment, a result of categorization module 800 may dictates or impact sorting of the package within the mailroom as well as the content of the notification email. In an exemplary embodiment, actions module 812 may conduct various actions based on an exemplary categorization by categorization module 800. Exemplary actions may include the following:

Confidential package: A member or target recipient may be notified with a warning to collect the package in-person and other pickup options may be locked. In an exemplary embodiment, tore frequent reminders setting may be activated entailing reminders at a higher frequency that normal reminders. In an exemplary embodiment, a package marked as confidential may be placed in a separate section for confidential packages.

Time-Sensitive package: A member or target recipient may be notified with a warning to collect the package at their earliest. In an exemplary embodiment, tore frequent reminders setting may be activated entailing reminders at a higher frequency that normal reminders. In an exemplary embodiment, a package marked as time-sensitive may be placed in a separate section for priority packages.

International package: A member or target recipient may be notified with a warning to collect this package at their earliest. In an exemplary embodiment, tore frequent reminders setting may be activated entailing reminders at a higher frequency that normal reminders. In an exemplary embodiment, a package marked as international package may be placed in a separate section for priority packages.

Oversize package: A member or target recipient may be notified with the package dimension and weight details, asking the member to come prepared for pickup. In an exemplary embodiment, a package marked as oversize may be placed in a separate section for oversized packages.

Fragile package: A member or target recipient notified with a warning to collect this package at their earliest. In an exemplary embodiment, a package marked as fragile may be placed in a separate section for fragile packages.

Routine package: A member or target recipient may be notified. In an exemplary embodiment, a package marked as routine may be placed in a routine section of the mailroom.

In an exemplary embodiment, once a target package recipient arrives at a mailroom, two different exemplary approaches may be utilized to enable the target package recipient to pick up their package(s).

In a first exemplary approach, smart labelling of packages, such that the packages belonging to the members from the same business may kept together, may be utilized. Such a labelling scheme may be designed to ease the pickup process when a designated member from a business intends to pick all the packages belonging to members from his/her business.

In a second exemplary approach, Augmented Reality (AR) may be utilized for placing the packages in the mailroom. The MRA scans the package after placing it in its appropriate shelf and the AR technology may guide the MRA to the precise location during pickup.

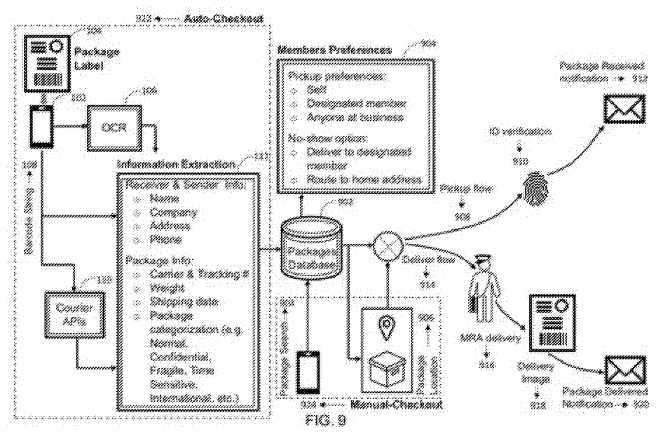

FIG. 9 illustrates an exemplary flow of handing over the package to a recipient, consistent with one or more exemplary embodiments of the present disclosure.

For Auto-Checkout 922, a package may be picked up in from of a mail room assistant (MRA) An exemplary MRA may scan package to get an associated package log entry from the Packages Database 902. After capturing the Parcel Label Image 104, all the normal scan modules, enclosed within 922, may be run on the image, but with variable priorities. In an exemplary embodiment, Pickup option on Scanning Screen 200 in FIG. 2, may be used to scan the package for auto-checkout 922 flow. In an exemplary embodiment, barcode recognition may take precedence over OCR because it is more efficient in terms of time efficiency. The output from each of the modules may be matched against all the package log entries in the Packages Database 902. If a match is found, details may be displayed on a screen and a user may proceed with the checkout. In an exemplary embodiment, Manual Checkout 924 may be utilized in an exemplary scenario for when a member/target recipient comes to the mailroom to receive their package. An exemplary MRA may search for the concerned package using the Manual Search 904 capability. Utilizing, returned results against a package may allow a user to locate the package 906 within the mailroom, either by the tag number or utilizing augmented reality.

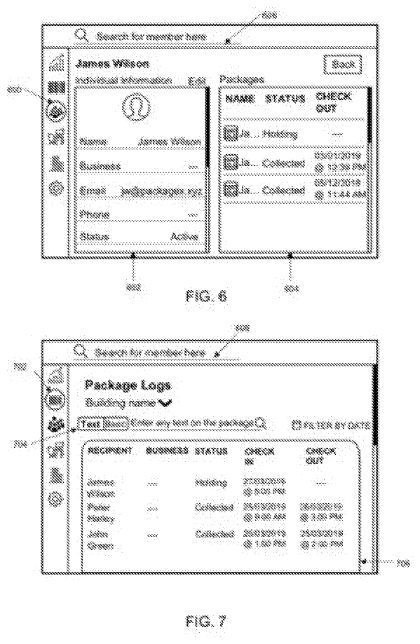

Once a package log has been retrieved from the Packages Database 902, either through the Auto-Checkout 922 or Manual Checkout 924, the user may be prompted to verify the identity of a pickup person 910, either through fingerprint match (Touch-ID), Facial recognition, NFC bump using NFC tags, or via ID card scan. In an exemplary embodiment, in Pickup flow 908. “NFC bump” may refer to bringing two NFC-capable devices together, for example, where one acts as a NFC reader/writer and the other acts as a NFC tag for the purpose of exchanging information. The device acting as a tag, may be a smart phone emulating a NFC tag. In an exemplary embodiment, both devices may have reader/writer functionality, and one may initiate pushing information to the other or attempting to receive information from the other, as though the other device is a fixed NFC tag. In an exemplary embodiment, a delivering mobile device may check-in at a delivery location using a fixed NFC tag instead of via an NFC bump. In an exemplary embodiment, a user may collect a digital signature of the receiver or the person who has come to pick up the package. For example, FIG. 5 illustrates a Collect Signature screen of a mobile application, consistent with one or more exemplary embodiments of the present disclosure. In detail, FIG. 5 shows “Collect Signature” screen from mobile application, where 502 is a place for signature. The user may switch the package recipient to another member using 504, in case, the package is to be handed over to the person other than the person to whom this package was originally assigned. Finally, the user may officially complete the pickup process by selecting Done 506.

In an exemplary embodiment, once an identity and authorization of a pickup member or target package recipient is verified, a user or a mail room assistant may hand over the package to the member and package received notification 912 may be sent to the owner of the package.

In an exemplary embodiment, a target package recipient, sender, or a building administrator may allow for a package pickup by members other than the target package recipient. For example, in Member Preferences 904 portal a member may set permissions for other member to pick their package.

In exemplary embodiments, members may specify in their preferences that if a package is not picked up within a certain time limit, permission to pickup may be extended to alternative individuals or their package may be forwarded to another address at their cost.

In an exemplary embodiment, additional delivery flow 914 may allow a Mail Room Administrator (MRA) to hand-deliver a package to the member's office. In addition to clearing up mailroom space, hand delivery may also facilitate the members working outside the mailroom office hours. In an exemplary embodiment, the MRA may capture a photo of the package drop area 918 and the image may be sent as a signature in the package delivery notification 920 to the package owner.

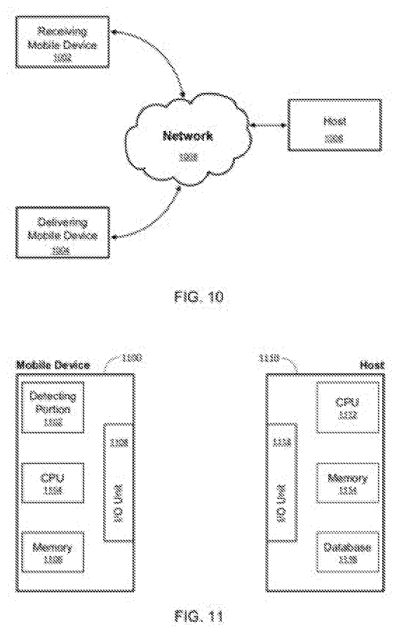

FIG. 10 shows a diagram of a system for notifying, routing and checking out of processed packages, consistent with one or more exemplary embodiments of the present disclosure.

In detail, FIG. 10 illustrates an exemplary system for signing for a delivered package. The exemplary system may include a receiving mobile device 1002, a delivering mobile device 1004, and/or host 1006, connected via network 1008. The receiving mobile device 1002 may be in possession of and/or accompanying a party receiving a shipped package, while delivering mobile device 1004 may be in possession of and/or accompanying a party delivering the shipped package. Host 1006 may be associated with a third-party application running on the receiving mobile device 1002 and/or delivering mobile device 1004. In an exemplary embodiment, the host 1006 may be associated with a delivery company and may store data relevant to delivery of the package.

The network 1008 may be a shared, public, or private network, may encompass a wide area or local area, and may be implemented through any suitable combination of wired and/or wireless communication networks. Furthermore, the network 1008 may comprise a local area network (LAN), a wide area network (WAN), an intranet, or the Internet. The Network 1008 may be a cloud network, a mesh network, or some other kind of distributed network. In some embodiments, some combination of receiving mobile device 1002, delivering mobile device 1004, and/or host 1006 may be directly connected, via a wired or wireless connection, instead of connecting through the network 1008.

The delivering mobile device 1004 may accompany a party delivering a package to a designated destination. The delivering mobile device 1004 may collect location information and may publish that location information via host 1006. For example, the delivering mobile device 1004 may periodically send its location to the host 1006.

The receiving mobile device 1002 may track the location of the package by interrogating the host 1006 on the whereabouts of the delivering mobile device 1004. The receiving mobile device 1002 may also determine from the host 1006 whether the package is in transit to its designated destination, out for delivery, and/or when the package is expected to be shipped or delivered. In general, the receiving mobile device 1002 may retrieve various types of information associated with the order or shipment of the package from the host 1006. In some embodiments, the receiving mobile device 1002 may receive information directly from delivering mobile device 1004.

The delivering mobile device 1004 may still be in progress to deliver the package to an address or location designated with the order. While delivering mobile device 1004 is on the way, the receiving mobile device 1002 may indicate to the host 1006 that it would like the delivering mobile device 1004 to deliver the package to a current location of the mobile device 1004 or some other location. The delivering mobile device 1004 then take an alternative route to deliver the package to the new designated location.

At delivery, the delivering mobile device 1004 may check-in at a delivery location, for example, with the receiving mobile device 1002, and may cause an encrypted electronic token to be transferred to receiving mobile device 1002. The receiving mobile device 1002 may decrypt the electronic token, use touch ID, Face detection or NFC to sign for the package.

The system in FIG. 10 is exemplary, and the number and distribution of the various entities shown may be different depending on specific embodiments. For example, the components in system may be combined and/or distributed over multiple entities, including other computers, handheld computers, mobile phones, tablet computers, or other computing platform. Thus, the configuration described in the system is an example only and is not intended to be limiting. The receiving mobile device 1002 may identify a package as being in transit. For example, receiving mobile device 1002 may receive a notification from the host 1006 that the package is out for delivery to a designated destination. The host 1006 may be monitoring the status of delivering mobile device 1004 to determine its location and whether or not it is associated with the package. When host 1006 determines that the package is out for delivery with delivering mobile device 1004, it may send the notification to receiving mobile device 1002.

Next, the receiving mobile device 1002 may send a message to the host 1006, requesting that the package be delivered to a location of the receiving mobile device 1002. For example, a party in possession of and/or accompanying receiving mobile device 1002 may be out to lunch and may want the package delivered to their current location instead of a location designated with the original order. In disclosed embodiments, the receiving mobile device 1002 may specify its current location for delivery if it determines that the package will be delivered within a certain amount of time (e.g., 30 minutes), for example. Alternatively, the receiving mobile device 1002 may specify another location for delivery if the package will be delivered at a later time (e.g., in 2 hours), for example. In this way, the receiving mobile device 1002 may dynamically adjust the delivery location based on real-time circumstances. In some embodiments, the delivery company may charge extra for a change in delivery location. Alternatively, receiving mobile device 1002 may not do anything to continue with the delivery of the package to the mailroom as discussed in the flow above.

The receiving mobile device 1002 may then determine whether or not the package is ready to be received. For example, the receiving mobile device 1002 may receive a notification from the host 1006 that the delivering mobile device 1004 is within a predetermined distance or time period from the receiving mobile device 1002, mailroom, or the designated location. This determination may be made in accordance with GPS information. For example, the host 1006 may monitor the location of the delivering mobile device 1006 and send a notification to the receiving mobile device 1002 when the location information (such as GPS coordinates) show the delivering mobile device 1004 at the same or similar GPS coordinates as the receiving mobile device 1002, the mailroom, or the new delivery location. For example, the host 1006 may notify the receiving mobile device 1002 that the package is ready to be received when the delivering mobile device 1004 is near the front door, the loading dock, or in the mailroom.

If the package is not ready to be received, then the receiving mobile device 1002 keeps checking until the package is ready to be received. If the package is ready to be received, then the receiving mobile device 1002 may enable the delivering mobile device 1004 to check-in at a delivery location, for example, at the receiving mobile device 1002, mailroom, and/or new delivery location. This may be done using a form of location tracking that is more precise than GPS. For example, the delivering mobile device 1004 may exchange short-range messages with the receiving mobile device 1002, such as via Bluetooth, an NFC bump, and/or a barcode scan. The check-in may ensure that a delivery party actually delivers the package directly to a delivery location and/or receiving party. The receiving mobile device 1002 may send a confirmation of the check-in to the host 1006. In this way, the host 1006 can ensure that the delivering party delivered the package at the location requested by the recipient.

Next, the receiving mobile device 1002 may access an encrypted electronic token associated with the package. For example, during the check-in, the delivering mobile device 1004 may transfer the encrypted electronic token to the receiving mobile device 1002 or to the mailroom device. Alternatively or additionally, the receiving mobile device 1002 may scan or read the encrypted electronic token from the package, such as from a barcode or an RFID tag. In some embodiments, the host 1006 may send the encrypted electronic token to the receiving mobile device 1002 via the network 1008 or otherwise, either at the time of check-in or beforehand, such as at the time the product was ordered.

The encrypted electronic token may have been encrypted by a public key associated with a particular party, such as a party who placed the original order, or the mailroom of the organization. Because the key may be public, it may have been accessible to the retailer, for example, who may have generated a token and encrypted the generated token when the order was placed or shipped, or at any other time.

The receiving mobile device 1002 may then electronically sign for the package by decrypting the encrypted token. For example, the receiving mobile device 1002 may possess a corresponding private key of a certain party. The private key may be able to undo the encryption of the token that was performed using the public key. Thus, the receiving mobile device 1002 may be able to decrypt the encrypted electronic token to determine the original electronic token. The receiving mobile device 1002 may send the decrypted electronic token to the host 1006 to verify that a party in possession of and/or accompanying receiving mobile device 1002 is authorized to receive the package.

FIG. 11 devices of an exemplary system, consistent with one or more exemplary embodiments of the present disclosure. In an exemplary embodiment, the exemplary system may be utilized in context of all aspects taught within this disclosure but also specifically with respect to FIGS. 1A-C. Exemplary system may include mobile device 1100 and host 1110. Mobile device 1100 may be similar to the receiving mobile device 1002 and/or delivering mobile device 1004, and the host 1110 may be similar to the host 1006. Both the mobile device 1100 and the host 1110 may include general-purpose computing components configured to execute special-purpose instructions or code to perform certain actions.

Mobile device 1100 may include the detecting portion 1102, which may include one or more software and/or hardware components for collecting data, such as environmental data. For example, detecting portion 1102 may collect location information about itself. In some embodiments, location information may include the use of a Global Positioning System (GPS). Alternately, location information may be determined through cellular triangulation, wireless network association, the capture of fixed location scan, an NFC bump, or the capture of mobile location scan.

The Mobile device 1100 may also include Central Processing Unit (CPU) 1104 and a memory 1106 to process data, such as the collected environmental data, inputted data, or data retrieved from a storage device. The CPU 1104 may include one or more processors configured to execute computer program instructions to perform various processes and methods. The CPU 1104 may read the computer program instructions from the memory 1106 or from any computer-readable medium. The memory 1106 may include Random Access Memory (RAM) and/or read only memory (ROM) configured to access and store information and computer program instructions. The memory 1106 may also include additional memory to store data and information and/or one or more internal databases to store tables, lists, or other data structures.

The mobile device 1100 may include an I/O Unit 1108 for sending data over a network or any other medium. For example, I/O Unit 1100 may send data over a network, point-to-point, and/or point-to-multipoint connection either wirelessly or over a cable.

The host 1110 may include a CPU 1112 and/or a memory 1114, which may be similar to the CPU 1104 and the memory 1106 from the mobile device 1100. The Host/Storage Device 1110 may also include a database 1116. The database 1116 may store large amounts of data, and may include a magnetic, semiconductor, tape, optical, or other type of storage device. In some embodiments, the database 1116 may store historical data for auditing purposes. The Host/storage device 1110 may include an I/O Unit 1118 for communicating with the mobile device 1100. The I/O Unit 1118 may be similar to I/O Unit 1108 on the mobile device 1100. The devices may also include encryption and decryption mechanisms to transmit data in a secure manner.

The system in FIG. 11 is exemplary only and the number and distribution of the various entities shown may be different depending on specific embodiments. For example, in some embodiments, the mobile device 1100 may not include the detecting portion 1102, CPU 1104, and/or memory 1106. In some embodiments, the host 1110 may be distributed over multiple entities, including other distribution systems, sensors, computers, handheld computers, mobile phones, tablet computers, or other computing platform. The mobile device 1100 may similarly be implemented or distributed over any computing platform. Thus, the configuration described in the system of FIG. 11 is an example only and is not intended to be limiting.

While certain features and embodiments of the invention have been described, other embodiments of the invention will be apparent to those skilled in the art from consideration of the specifications and practice of the embodiments of the invention disclosed herein. Furthermore, although aspects of embodiments of the present invention have been described in part as software, computer-executable instructions, and/or other data stored in memory and other storage mediums, one skilled in the art will appreciate that these aspects can also be stored on or read from other types of tangible, non-transitory computer-readable media, such as secondary storage devices, like hard disks, floppy disks, or a CD-ROM, or other forms of RAM or ROM. Further, the steps of the disclosed methods may be modified in various ways, including by reordering steps and/or inserting or deleting steps, without departing from the principles of the invention.

It is intended that the specification and examples be considered as exemplary only, and the embodiments described herein are not to be construed as restricting the scope of the invention. The invention is capable of being deployed in various other fashions and environments owing to susceptibility to changes and modifications, without essentially departing from the core concept of the invention. Thus, the true scope and spirit of the invention is indicated by the following claims and any change or modification or alteration that may be equivalent to these claims or may be derived or inferred from them.

What is claimed:

1. A computer-implemented method for routing of one or more incoming packages, comprising:
capturing one or more images, utilizing an image capturing device, of each respective package of the one or more incoming packages;
extracting, utilizing one or more processors, data from the one or more captured images,
determining, utilizing the one or more processors, likelihood of whether an intended recipient exists by comparing extracted data with a members list from one of more databases associated with a physical location;
generating, utilizing the one or more processors, a notification to the intended recipient responsive to determining that the intended recipient exists;
generating, utilizing the one or more processors, a list of possible recipients responsive to determining a likelihood that a group of potential users are the intended recipient;
sending, utilizing the one or more processors, a notification to the intended recipient;
associating, utilizing the one or more processors, a physical space with a virtual space in the mailroom;
associating, utilizing the one or more processors, a respective location in the virtual space with the respective package; and
displaying, using an augment reality device, the respective location.

2. A method for routing of one or more incoming packages, comprising:
capturing one or more images, utilizing an image capturing device, of each respective package of the one or more incoming packages;
extracting, utilizing one or more processors, data from the one or more captured images,
determining, utilizing the one or more processors, likelihood of whether an intended recipient exists by comparing extracted data with a members list from one of more databases associated with a physical location;
generating, utilizing the one or more processors, a notification to the intended recipient responsive to determining that the intended recipient exists;
generating, utilizing the one or more processors, a list of possible recipients responsive to determining a likelihood that a group of potential users are the intended recipient.

3. The method of claim 2, wherein determining the likelihood that a group of potential users are the intended recipient comprises a first range of likelihood that the group of potential users are the intended recipient.

4. The method of claim 3, wherein the first range of likelihood is more than seventy percent

5. The method of claim 4, further adding information, to the one or more databased, related to a new recipient by providing a user an information inputting interface.

6. The method of claim 2, wherein extracting data from the one or more captured images comprises one or more of:
extracting barcode information; and
extracting text utilizing optical character recognition (OCR).

7. The method of claim 2, wherein extracting data from the one or more captured images comprises determining field regions utilizing pattern-extraction, wherein the field regions comprise one or more of sender information, receiver information, and barcode region.

8. The method of claim 2, further comprising:
sending a notification to the intended recipient.

9. The method of claim 2, further comprising:
categorizing each of the respective one or more packages as one or more of routine, confidential, time-sensitive, international, oversized, and fragile.

10. The method of claim 2, wherein sending a notification to the intended recipient comprises sending an email including the one or more captured images.

11. The method of claim 2, further comprising:
associating a physical space with a virtual space in the mailroom; and
associating respective location in the virtual space with the respective package.

12. The method of claim 2, wherein determining that the intended recipient exists comprises determining utilizing fuzzy matching that a threshold number associated between the extract information and information in the one or more database is over a first threshold, the first threshold higher than ninety percent.

13. A system for utilizing tracking one or more incoming packages, the system comprising:
a processor; and
a storage device that stores a set of instructions that when executed by the processor perform a method, the method comprising:
capturing one or more images, utilizing an image capturing device, of each respective package of the one or more incoming packages;
extracting, utilizing one or more processors, data from the one or more captured images,
determining, utilizing the one or more processors, likelihood of whether an intended recipient exists by comparing extracted data with a members list from one of more databases associated with a physical location;
generating, utilizing the one or more processors, a notification to the intended recipient responsive to determining that the intended recipient exists;
generating, utilizing the one or more processors, a list of possible recipients responsive to determining a likelihood that a group of potential users are the intended recipient.

14. The system of claim 13, wherein determining the likelihood that a group of potential users are the intended recipient comprises a first range of likelihood that the group of potential users are the intended recipient.

15. The system of claim 14, wherein the first range of likelihood is more than seventy percent.
